(19) United States
(12) Patent Application Publication
(10) Pub. No.: US 2025/0286634 A1
(43) Pub. Date: Sep. 11, 2025

(54) DEVICE AND METHOD FOR CALIBRATION OF A PHASED ARRAY DEVICE

(71) Applicant: HUAWEI TECHNOLOGIES CO., LTD., Shenzhen (CN)

(72) Inventors: Christian MAZZUCCO, Munich (DE); Damiano BADINI, Milan (IT); Angelo MILANI, Segrate (IT)

(21) Appl. No.: 19/215,549

(22) Filed: May 22, 2025

Related U.S. Application Data
(63) Continuation of application No. PCT/EP2022/082860, filed on Nov. 22, 2022.

(51) Int. Cl. H04B 17/12; H01Q 3/26; H04B 17/21

(52) U.S. Cl. CPC H04B 17/12; H01Q 3/267; H04B 17/221

(57) ABSTRACT

The disclosure relates to the calibration of a phased array device for the transmission or reception of radio frequency (RF) waves, especially microwaves. The phased array device comprises an antenna array, transmission circuitry, a coupling structure, and reception circuitry. The phased array device calibrates the transmission circuitry (or the reception circuitry) based on one or more RF signals that are received by the reception circuitry from the transmission circuitry via the coupling structure.

### CROSS-REFERENCE TO RELATED APPLICATIONS

This application is a continuation of International Application No. PCT/EP2022/082860, filed on Nov. 22, 2022, the disclosure of which is hereby incorporated by reference in its entirety.

### TECHNICAL FIELD

The disclosure relates to the calibration of a phased array device for the detection and transmission of waves. The disclosure proposes a phased array device, and a corresponding method for operating the phased array device. The phased array device comprises an antenna array, a transmission circuitry, and a reception circuitry.

### BACKGROUND

For successful beam forming and scanning in phased array systems, it is essential to precisely set the amplitude and phase of each antenna element channel. However, considerable amplitude and phase differences among the channels can occur due to the different radio frequency (RF) hardware connected to each antenna element. Further, the phase and amplitude characteristics of conventional RF devices depend on frequency and temperature and usually drift in time. In order to equalize the phase and amplitude effects of the channels, phased array systems are calibrated once during manufacturing and periodically during functioning.

### SUMMARY

Conventional phased array calibration methods are usually too time consuming or require complex measurements setup that are not suitable for mass production. Four of the most commonly used calibration methods are: the near-field scanning probe method, the peripheral fixed probes method, the calibration lines method, and the mutual coupling method.

For near-field scanning probe methods a test antenna (probe) is scanned across the antenna array to directly measure the relative phase and amplitude of each antenna element. Using a near-field scanning probe, an array can be precisely and directly (i.e. without previous calibration) calibrated. However, it is a time consuming and costly method that requires a complex setup involving automated precise probe movement. Therefore, this method is generally more suitable for initial factory calibration of phased array systems rather than periodic in-field calibration.

For calibration line methods, transmission lines are connected to each antenna element for the periodic in-field calibration of small phased array systems. These calibration lines sample the signals received and transmitted by the antenna elements. The measured signals are then used to calculate the phase/amplitude differences among the antenna element channels.

To successfully calibrate a phased array system using this method, the phase shifts and amplitude losses caused by the transmission lines and the couplers that connect them should be equal or predetermined.

Nevertheless, the effects of different antenna elements cannot be equalized using calibration lines which are connected behind the antennas. Thus, for successful in-field calibration, the antenna elements, the calibration lines, and the couplers need to be calibrated in the factory first. Although these three components can each be measured separately in the factory, it may be more accurate if they are measured simultaneously while connected to each other (and to the other components of the system). This may be done using a scanning probe in the factory. In addition, for periodic in-field calibration, it should be assumed that the characteristics of the antenna elements, transmission lines, and couplers do not change in time. However, if one of these components fails and is replaced, factory calibration should be repeated.

Conventionally, the steps of calibrating a phased array system can be summarized as follows:
The phase/amplitude differences among the channels are measured in the factory using an appropriate method.
The measurements are repeated for transmit and receive modes.
The measurements are repeated at different frequencies and temperatures that the system is required to operate at.
If phase shifters and attenuators are used (i.e., analog or hybrid beamforming), the calibration procedure can be repeated for each phase and amplitude step.
The calibration should be repeated in the field periodically to compensate for the phase/amplitude shifts that occur in time due to aging or replacement of parts.

For calibration, it is not necessary to measure the actual phase/amplitude responses (the phase/amplitude shift of an output relative to an input) of each channel. If the input signals are equal, then calibration can be done by measuring the output signals relative to each other. If the input signals are not equal, then the outputs should first be normalized (divided by the inputs) before comparing them to each other.

Step 3 is beneficial because the phase/amplitude shifts of most RF devices depend on the temperature and frequency and the behavior of each channel would be different. If constant phase shifters are used, the frequency responses of the channels should be kept as similar to each other as possible. This can be achieved by using RF devices whose frequency responses are similar and by equalizing the path lengths of each channel. If the path lengths are different, phase shifter compensation would be useful only at a specific frequency and not for the other frequencies in the bandwidth.

Step 4 is beneficial because the amplitude and/or phase shifts induced by attenuators and phase shifters vary with their amplitude and phase settings, respectively. Ideally, the attenuator and phase shifter steps are calibrated for all combinations. For example, if there are N phase steps and M attenuator steps, calibration should be repeated N×M times due to the fact that the impedance mismatch (return loss) between the attenuator and phase shifter might depend on the phase and amplitude settings. However, if very high accuracy is not required, it might be sufficient to calibrate the phase shifters and attenuators individually which requires only N+M calibration steps. Further, even though phase shifters do not cause much attenuation, the attenuators can cause considerable phase shifts. Thus, both phase and amplitude may be measured for each attenuator setting.

Calibration may be repeated for all beam scan angles instead of all phase shifter settings. For large arrays and for high-bit phase shifters, beam scan angle calibration takes much less time; however, scan angle calibration is less reliable than phase shifter calibration due to the fact that a phase shifter step that, in-theory, is not used for beam scanning might, in practice, have to be used to equalize the phase shifts of the channels.

Notably, step 3 is required only for Analog Beam Forming (ABF) systems. It does not apply to systems that employ full Digital Beam Forming (DBF) which do not require phase shifters or attenuators. Conventionally, the factory calibration procedure can be completed much more quickly for full DBF systems.

After all the measurements mentioned above are made, the measured complex values may be stored as a table in the system software (calibration coefficients). The phase and amplitude values can be stored as complex numbers (i.e., real and imaginary) or in two separate tables for amplitude and phase. For ABF systems, the amplitude coefficients should be divided by the smallest coefficient to normalize and lower their values as much as possible. That way, the extra attenuations to be applied to equalize channel responses during system operation could be minimized. It should be noted that all values should be larger than 1 as they represent attenuation amounts. Unlike amplitude values, there is no need to normalize the phase shifts. During system operation in the field, the phase/amplitude shift of each channel is compensated using the appropriate value from the calibration coefficients table based on the current phase shifter and attenuator settings as well as the frequency and temperature. In ABF systems, this is achieved by applying extra attenuations and phase shifts. In full DBF systems, the complex calibration coefficients can be applied digitally by the processor.

The amplitude/phase shifts of RF components usually drift in time due to aging. Thus, periodic recalibration of the phased array in the field and updating the calibration coefficients is conventionally required. In addition, when a failed component (such as a chipset or a RF chain) is replaced, the phase array may need to be calibrated again. Calibration may be done while data transmission is paused (offline tracking) or as a background process (online tracking).

In view of the above, this disclosure aims to provide a phased array device that can be efficiently calibrated. One objective is to reduce cost and/or time requirements for the calibration of phased array devices in factories and/or in-field. Another objective is to avoid the use of complex mechanical systems needed for the movement of an external probe for calibration.

These and other objectives are achieved by this disclosure as described in the enclosed independent claims. Advantageous implementations are further defined in the dependent claims.

A first aspect of this disclosure provides a phased array device for transmitting a RF wave, wherein the phased array device comprises: an antenna array comprising two or more antennas; transmission circuitry connected or connectable to the antenna array and configured to generate RF signals for driving the antenna array; a coupling structure; and reception circuitry connected or connectable to the transmission circuitry via the coupling structure and configured to receive one or more RF signals from the transmission circuitry via the coupling structure; wherein the phased array device is configured to calibrate the transmission circuitry based on the one or more RF signals received by the reception circuitry.

In the present disclosure, “Radio frequency” (RF) refers to frequencies of up to 300 Gigahertz (GHz). The RF spectrum is thus understood to include microwave frequencies.

In one embodiment, the one or more RF signals received by the reception circuitry are RF signals generated by the transmission circuitry specifically for the purpose of calibration (rather than for driving the antenna array) and may be referred to as calibration signals. The transmission circuitry may generate the calibration signals during a calibration period and generate RF signals for driving the antenna array during a transmission period. RF signals for driving the antenna array may be referred to as feed signals.

In another embodiment, the one or more RF signals received by the reception circuitry include one or more feed signals generated by the transmission circuitry for driving the antenna array. In such an embodiment, the reception circuitry “listens” to the transmission circuitry during normal operation of the phased array device and uses at least one of the feed signals as a calibration signal.

In an implementation form of the first aspect, the transmission circuitry comprises a first node connected or connectable to an antenna of the antenna array and configured to provide an RF signal for driving the antenna, wherein the first node is connected or connectable to the coupling structure.

The reception circuitry is thus enabled to receive a RF signal from the first node of the transmission circuitry via the coupling structure. The phased array device is thus enabled to calibrate the transmission circuitry based on the received RF signal.

In this disclosure, the term “node” refers to a point of the circuit at which a signal is provided or received. The signal may be a balanced or an unbalanced signal. In the first case (balanced signal), the term node refers to what is commonly known as a “port”. A port is a composite node, consisting of two terminals. In other words, a port is a pair of elementary nodes for providing or receiving a balanced signal.

In a further implementation form of the first aspect, the phased array device comprises a feed line from the first node of the transmission circuitry to the antenna, wherein the coupling structure comprises a coupler connected to the feed line.

The coupling structure is thus enabled to pick off the signal from the feed line. The feed line may comprise a balanced feed line and it may comprise an unbalanced feed line. The feed line may further comprise a balun.

The coupling structure may comprise two or more couplers, each connected to a respective feed line.

The phased array device may comprise one or more feed lines. Each of the one or more feed lines may be connected to one coupler, for example only one coupler, of the two or more couplers.

In a further implementation form of the first aspect, the reception circuitry comprises a first node connected or connectable to the first node of the transmission circuitry via the coupling structure, for receiving a RF signal from the first node of the transmission circuitry via the coupling structure.

The phased array device is thus enabled to calibrate the transmission circuitry based on the RF signal from the node of the transmission circuitry received at the first node.

In a further implementation form of the first aspect, the phased array device is configured to determine a value of a transfer function m_{iA} based on the RF signal from the first node of the transmission circuitry received at the first node of the reception circuitry, and calibrate the transmission circuitry based on the value of the transfer function m_{iA}.

The phased array device is thus enabled to calibrate the transmission circuitry based on the value of the transfer function m_{iA}. In one embodiment, the phased array device determines a value of a transfer function T_{iC} (describing transfer of a signal from the transmission circuitry to a node of the coupling structure) and calibrates the transmission circuitry based on the value of T_{iC}. The value of T_{iC} can be determined based on the identity m_{iA}=T_{iC}M_{iA}R_{A} or based on the identity

$${T}_{iC}^{2} = \frac{{m}_{iA} {m}_{iB}}{{M}_{iA} {M}_{iB} {R}_{A} {R}_{B}} .$$

In a further implementation form of the first aspect, the reception circuitry comprises a second node connected or connectable to the first node of the transmission circuitry via the coupling structure, for receiving an RF signal from the first node of the transmission circuitry via the coupling structure.

The phased array device is thus enabled to calibrate the transmission circuitry based on the following two signals: the RF signal from the first node of the transmission circuitry received at the first node; and the RF signal from the first node of the transmission circuitry received at the second node.

The calibration can thus be done more accurately.

In one embodiment, the RF signal received at the first node and the RF signal received at the second node are the same signal from the node of the transmission circuitry, received at the first node and at the second node of the reception circuitry, respectively. In another embodiment, the first node and the second node receive a first and a second RF signal from the node of the transmission circuitry, respectively, wherein the first and the second RF signal are two successive signals.

In a further implementation form of the first aspect, the phased array device is configured to determine a transfer function m_{iB} based on the RF signal from the first node of the transmission circuitry received at the second node of the reception circuitry;
calibrate the transmission circuitry based on the value of the transfer function m_{iB}.

The phased array device is thus enabled to calibrate the transmission circuitry based on both transfer functions m_{iA} and m_{iB}. The calibration can thus become more accurate.

In one embodiment, the phased array device determines a value of the transfer function T_{iC} based on both m_{iA} and m_{iB} and calibrates the transmission circuitry based on the value of T_{iC}. The value of T_{iC} can be determined using the two identities m_{iA}=T_{iC}M_{iA}R_{A} and m_{iB}=T_{iC}M_{iB}R_{B} as such, or using the related identity

$${T}_{iC}^{2} = \frac{{m}_{iA} {m}_{iB}}{{M}_{iA} {M}_{iB} {R}_{A} {R}_{B}} .$$

In a further implementation form of the first aspect, the transmission circuitry comprises a second node connected or connectable to the first node of the reception circuitry, for transmitting a RF signal to the first node of the reception circuitry.

The phased array device is thus enabled to calibrate the transmission circuitry based on the following three RF signals: the RF signal from the first node of the transmission circuitry received at the first node of the reception circuitry; the RF signal from the first node of the transmission circuitry received at the second node of the reception circuitry; and the RF signal from the second node of the transmission circuitry received at the first node of the reception circuitry.

The transmission circuitry can thus be calibrated more accurately.

In a further implementation form of the first aspect, the phased array device is configured to determine a transfer function m_{BA} based on the RF signal from the second node of the transmission circuitry received at the first node of the reception circuitry.

The phased array device is thus enabled to calibrate the transmission circuitry based on the three transfer functions m_{iA}, m_{iB} and m_{BA}. The transmission circuitry can thus be calibrated even more accurately.

In one embodiment, the phased array device determines a transfer function T_{iC} describing transfer from the first node of the transmission circuitry to a node of the coupling structure) using a computation that is based mathematically on the identity m_{BA}=T_{B}M_{iB}M_{iA}R_{A}. For example, the identity

$${T}_{iC}^{2} = \frac{{m}_{iA} {m}_{iB}}{{M}_{iA} {M}_{iB} {R}_{A} {R}_{B}}$$

can be exploited.

The transfer function T_{iC} can thus be computed (up to a factor of −1, i.e. with a phase ambiguity of 180 degrees) from the three measured transfer functions m_{iA}, m_{iB} m_{AB} and the ratio T_{A}/R_{A}. The ratio T_{A}/R_{A} can be measured at the factory or during maintenance, for example.

In a further implementation form of the first aspect, the phased array device comprises a feed line from the first node of the transmission circuitry to the antenna, and a signal line from the second node of the transmission circuitry to the first node of the reception circuitry, wherein the coupling structure comprises a coupler that connects the feed line to the signal line.

The first node of the reception circuitry is thus configured to receive both the RF signal from the first node and the RF signal from the second node of the transmission circuitry through the same signal line. In other words, the same signal line is used to carry both signals. Thus, a lean design can be achieved.

In a further implementation form of the first aspect, the second node of the reception circuitry is connected or connectable to the first node of the transmission circuitry via the following: the coupler and a portion of the signal line that extends from the coupler toward the second node of the transmission circuitry.

Thus, the second node of the reception circuitry is connected in an economic manner.

In a further implementation form of the first aspect, the second node of the reception circuitry is co-located with the second node of the transmission circuitry in a common location and is connected or connectable to the first node of the transmission circuitry via the following: the coupler and a portion of the signal line that extends from the coupler to the common location.

Thus, a transfer function of a RF signal from the second node of the transmission circuitry to the coupler (“backward path”) and a transfer function of a RF signal from a coupling point to the second node of the reception circuitry (“forward path”) may be approximately equal. It can then be shown mathematically that

$${T}_{iC}^{2} = \frac{{m}_{iA} {m}_{iB}}{{M}_{iA} {M}_{iB} {R}_{A} {R}_{B}} .$$

This identity facilitates calibrating the transmission circuitry.

In a further implementation form of the first aspect, the signal line comprises a transmission line or a waveguide.

In a further implementation form of the first aspect, calibrating the transmission circuitry comprises: adjusting a phase and/or a gain of the RF signal provided by the first node of the transmission circuitry to drive the antenna.

The feed signals for the antenna array can thus be equalized at least to some extent.

The phased array device may comprise a controller for computing the phase and/or the gain based on the one or more RF signals received by the reception circuitry, or for computing parameters equivalent to the phase and/or gain (i.e. parameters that enable the phased array devise to adjust the phase and/or the gain). The phased array device may comprise a non-volatile memory (connected to or integrated in the controller) for memorising the phase and/or the gain (or for memorizing one or more parameters that enable the controller to compute the phase and/or the gain). The controller may be further configured to adjust the phase and or the gain of the RF signal provided by the first node to drive the antenna.

The controller may be configured to perform operations similar to those described above for each of the antennas. Thus, the transmission circuitry can be calibrated for the entire array.

In a further implementation form of the first aspect, the coupling structure comprises multiple couplers arranged on the signal line, each coupler connected to a feed line of a respective antenna of the antenna array.

The multiple couplers may comprise the two or more couplers.

In a further implementation form of the first aspect, the reception circuitry is connected or connectable to the antenna array and configured to receive RF signals from the antenna array.

Thus, the phased array device can also be operated as a receive device.

A second aspect of this disclosure provides a phased array device for receiving a RF wave, wherein the phased array device comprises: an antenna array comprising two or more antennas; reception circuitry connected or connectable to the antenna array and configured to receive RF signals from the antenna array; a coupling structure; and transmission circuitry connected or connectable to the reception circuitry via the coupling structure and configured to transmit one or more RF signals to the reception circuitry via the coupling structure; wherein the phased array device is configured to calibrate the reception circuitry based on the one or more RF signals from the transmission circuitry received by the reception circuitry.

In an implementation form of the second aspect, the reception circuitry comprises a third node connected or connectable to an antenna of the antenna array and configured to receive an RF signal from the antenna, wherein the third node is connected or connectable to the coupling structure.

The transmission circuitry is thus enabled to transmit a RF signal to the third node of the reception circuitry via the coupling structure. The phased array device is thus enabled to calibrate the reception circuitry based on the received RF signal.

In a further implementation form of the second aspect, the phased array device comprises a feed line from the third node of the reception circuitry to the antenna, wherein the coupling structure comprises a coupler connected to the feed line.

The coupling structure is thus enabled to pick off the signal from the feed line. The feed line may comprise a balanced feed line and it may comprise an unbalanced feed line. The feed line may further comprise a balun.

The coupling structure may comprise two or more couplers, each connected to the feed line.

In a further implementation form of the second aspect, the transmission circuitry comprises a third node connected or connectable to the third node of the reception circuitry via the coupling structure, for transmitting a RF signal to the third node of the reception circuitry via the coupling structure.

The phased array device is thus enabled to calibrate the reception circuitry based on the RF signal transmitted from the third node of the transmission circuitry and received at the third node of the reception circuitry.

In a further implementation form of the second aspect, the phased array device is configured to determine a value of a transfer function m_{Ai} based on the RF signal from the third node of the transmission circuitry received at the third node of the reception circuitry, and calibrate the reception circuitry based on the value of the transfer function m_{Ai}.

The phased array device is thus enabled to calibrate the reception circuitry based on the value of the transfer function m_{Ai}. In one embodiment, the phased array device determines a value of a transfer function R_{iC} (describing transfer of a signal to the reception circuitry from a node of the coupling structure) and calibrates the reception circuitry based on the value of R_{iC}. The value of R_{iC} can be determined based on the identity m_{Ai}=T_{A}M_{iA}R_{iC} or based on the identity

$${R}_{i C}^{2} = \frac{{m}_{A i} {m}_{B i}}{{M}_{i A} {M}_{i B} {T}_{A} {T}_{B}} .$$

In a further implementation form of the second aspect, the transmission circuitry comprises a second node connected or connectable to the third node of the reception circuitry via the coupling structure, for transmitting a RF signal to the third node of the reception circuitry via the coupling structure.

The phased array device is thus enabled to calibrate the reception circuitry based on the following two signals: the RF signal from the third node of the transmission circuitry received at the third node of the reception circuitry; and the RF signal from the second node of the transmission circuitry received at the third node of the reception circuitry.

The calibration can thus be done more accurately.

Said RF signals may be a third and a fourth RF signal and/or may be two successive signals.

In a further implementation form of the second aspect, the phased array device is configured to: determine a transfer function m_{Bi} based on the RF signal from the second node of the transmission circuitry received at the third node of the reception circuitry; and
calibrate the transmission circuitry based on the value of the transfer function m_{Bi}.

The phased array device is thus enabled to calibrate the transmission circuitry based on both transfer functions m_{Ai} and m_{Bi}. The calibration can thus become more accurate.

In one embodiment, the phased array device determines a value of the transfer function R_{iC} based on both m_{Ai} and m_{Bi} and calibrates the transmission circuitry based on the value of R_{iC}. The value of R_{iC} can be determined using the two identities m_{Ai}=T_{A}M_{Ai}R_{iC} and m_{Bi}=T_{B}M_{Bi}R_{iC} as such, or using the related identity

$${R}_{i C}^{2} = \frac{{m}_{A i} {m}_{B i}}{{M}_{i A} {M}_{i B} {T}_{A} {T}_{B}} .$$

In a further implementation form of the second aspect, the reception circuitry comprises a second node connected or connectable to the third node of the transmission circuitry, for receiving a RF signal from the third node of the transmission circuitry.

The phased array device is thus enabled to calibrate the reception circuitry based on the following three RF signals: the RF signal from the third node of the transmission circuitry received at the third node of the reception circuitry; and the RF signal from the second node of the transmission circuitry received at the third node of the reception circuitry; and the RF signal from the third node of the transmission circuitry received at the second node of the reception circuitry.

The reception circuitry can thus be calibrated more accurately.

In a further implementation form of the second aspect, the phased array device is configured to determine a transfer function m_{AB} based on the RF signal from the third node of the transmission circuitry received at the second node of the reception circuitry.

The phased array device is thus enabled to calibrate the reception circuitry based on the three transfer functions m_{Ai}, m_{Bi} and m_{AB}. The reception circuitry can thus be calibrated even more accurately.

In one embodiment, the phased array device determines a transfer function R_{iC} (describing transfer to the third node of the reception circuitry from a node of the coupling structure) using a computation that is based mathematically on the identity m_{AB}=T_{A}M_{iA}M_{iB}R_{B}. For example, the identity

$${R}_{i C}^{2} = \frac{{m}_{A i} {m}_{B i}}{{M}_{i A} {M}_{i B} {T}_{A} {T}_{B}}$$

can be exploited.

The transfer function R_{iC} can thus be computed (up to a factor of −1, i.e. with a phase ambiguity of 180 degrees) from the three measured transfer functions m_{Ai}, m_{Bi} m_{AB} and the ratio T_{A}/R_{A}. The ratio T_{A}/R_{A} can be measured at the factory or during maintenance, for example.

In a further implementation form of the second aspect, the phased array device comprises
a feed line connecting the third node of the reception circuitry to an antenna of the antenna array, and a signal line from the second node of the reception circuitry to the third node of the transmission circuitry, wherein the coupling structure comprises a coupler that connects the feed line to the signal line.

The third node of the transmission circuitry is thus configured to transmit both the RF signal to the third node of the reception circuitry and the RF signal to the second node of the reception circuitry through the same signal line. In other words, the same signal line is used to carry both signals. Thus, a lean design can be achieved.

In a further implementation form of the second aspect, the second node of the transmission circuitry is connected or connectable to the third node of the reception circuitry via the following: the coupler and a portion of the signal line that extends from the coupler toward the second node of the reception circuitry.

Thus, the second node of the transmission circuitry is connected in an economic manner.

In a further implementation form of the second aspect, the second node of the transmission circuitry is co-located with the second node of the reception circuitry in a common location and is connected or connectable to the third node of the reception circuitry via the following: the coupler and a portion of the signal line that extends from the coupler to the common location.

Thus, a transfer function of a RF signal from the second node of the transmission circuitry to the coupler (“forward path” regarding the third node of the reception circuitry) and a transfer function of a RF signal from the coupling point to the second node of the reception circuitry (“backward path” regarding the third node of the reception circuitry) will be approximately equal. It can then be shown mathematically that

$${R}_{i C}^{2} = \frac{{m}_{A i} {m}_{B i}}{{M}_{i A} {M}_{i B} {T}_{A} {T}_{B}} .$$

This identity facilitates calibrating the transmission circuitry. The common location may be first common location.

The third node of the transmission circuitry may be co-located with the third node of the reception circuitry in a second common location and may be connected or connectable to the third node of the reception circuitry and/or the first node of the transmission circuitry via the following: the coupler and a portion of the signal line that extends from the coupler to the second common location.

In a further implementation form of the second aspect, the signal line comprises a transmission line or a waveguide.

In a further implementation form of the second aspect, calibrating the reception circuitry comprises: adjusting a phase and/or a gain of the RF signal received by the third node of the reception circuitry from the antenna.

The feed signals from the antenna array can thus be equalized at least to some extent.

The phased array device may comprise a controller for computing the phase and/or the gain based on the one or more RF signals received by the reception circuitry, or for computing parameters equivalent to the phase and/or gain (i.e. parameters that enable the phased array devise to adjust the phase and/or the gain). The controller may be further configured to adjust the phase and or the gain of the RF signal received by the third node of the reception circuitry from the antenna.

The controller may be configured to perform operations similar to those described above for each of the antennas. Thus, the reception circuitry can be calibrated for the entire antenna array.

In a further implementation form of the second aspect, the coupling structure comprises multiple couplers arranged on the signal line, each coupler connected to a feed line of a respective antenna of the antenna array.

The multiple couplers may comprise the two or more couplers.

In a further implementation form of the second aspect, the transmission circuitry is connected or connectable to the antenna array and configured to transmit RF signals to drive the antenna array.

Thus, the phased array device can also be operated as a transmit device.

A third aspect of this disclosure provides a method for operating a phased array device for transmitting a RF wave, wherein the phased array device comprises: an antenna array comprising two or more antennas; transmission circuitry connected or connectable to the antenna array; a coupling structure; and reception circuitry connected or connectable to the transmission circuitry via the coupling structure; wherein the method comprises: generating, with the transmission circuitry, RF signals for driving the antenna array, receiving, with the reception circuitry, one or more RF signals from the transmission circuitry via the coupling structure, and calibrating the transmission circuitry based on the one or more RF signals received by the reception circuitry.

The method of the third aspect may have implementation forms that correspond to the implementation forms of the phased array device of the first aspect. The method of the third aspect and its implementation forms achieve the advantages and effects described above for the device of the first aspect and its respective implementation forms.

A fourth aspect of this disclosure provides a method for operating a phased array device for receiving a RF wave, wherein the phased array device comprises: an antenna array comprising two or more antennas; reception circuitry connected or connectable to the antenna array; a coupling structure; and transmission circuitry connected or connectable to the reception circuitry via the coupling structure; wherein the method comprises: receiving, with the reception circuitry, RF signals from the antenna array, transmitting, with the transmission circuitry, one or more RF signals to the reception circuitry via the coupling structure, and calibrating the reception circuitry based on the one or more RF signals from the transmission circuitry received by the reception circuitry.

The method of the fourth aspect may have implementation forms that correspond to the implementation forms of the phased array device of the second aspect. The method of the fourth aspect and its implementation forms achieve the advantages and effects described above for the device of the second aspect and its respective implementation forms.

Further, in this disclosure the phrase “calibration line” and “signal line” may be used interchangeably.

It has to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows a phased array device according to an embodiment of this disclosure.

FIG. 2 shows a phased array device according to an embodiment of this disclosure.

FIG. 3 shows a phased array device according to an embodiment of this disclosure.

FIG. 4 shows the measurements that can be collected for each channel according to an embodiment of this disclosure.

FIG. 5 shows a phased array device comprising a single calibration line according to an embodiment of this disclosure.

FIG. 6 shows a phased array device according to an embodiment of this disclosure.

FIG. 7 shows an exemplary coupling structure according to an embodiment of this disclosure.

FIG. 8 shows an exemplary implementation of the coupling structure in the mechanic according to an embodiment of this disclosure.

FIG. 9 shows a probability density function of the error associated with the calibration of the phased array device according to an embodiment of this disclosure.

FIG. 10 shows exemplary radiation performances and numerical comparisons of: a phased array device according to an embodiment of this disclosure, a near-field scanning probe, and a HFSS simulation for a boresight radiation pattern.

FIG. 11 shows exemplary radiation performances and numerical comparisons of: a phased array device according to an embodiment of this disclosure, a near-field scanning probe, and a HFSS simulation for a 45° steered radiation pattern.

FIG. 12 shows the couplers dispersion of a phased array device according to an example of this disclosure.

FIG. 13 shows a method according to an embodiment of this disclosure.

FIG. 14 shows a method according to an embodiment of this disclosure.

### DETAILED DESCRIPTION OF EMBODIMENTS

Generally, a phased array device 100 according to embodiments of this disclosure comprises an antenna array 101 comprising two or more antennas 101a, 101d, transmission circuitry 102, a coupling structure 103, and reception circuitry 104. The reception circuitry 104 is connected or connectable to the transmission circuitry 102 via the coupling structure 103.

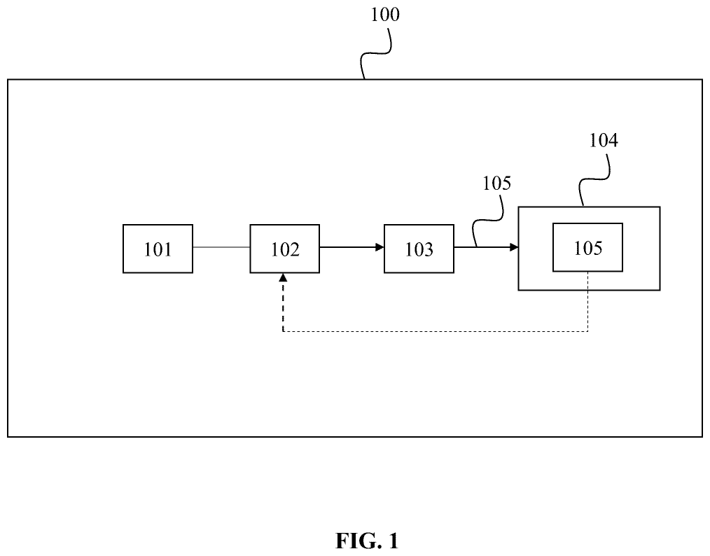

FIG. 1 shows a phased array device 100, wherein the transmission circuitry 102 is connected or connectable to the antenna array 101 and configured to generate RF signals for driving the antenna array 101. The reception circuitry 104 is configured to receive one or more RF signals 105 from the transmission circuitry 102 via the coupling structure 103. The phased array device 100 is configured to calibrate the transmission circuitry 102 based on the one or more RF signals 105, which is indicated with a dashed arrow in FIG. 1.

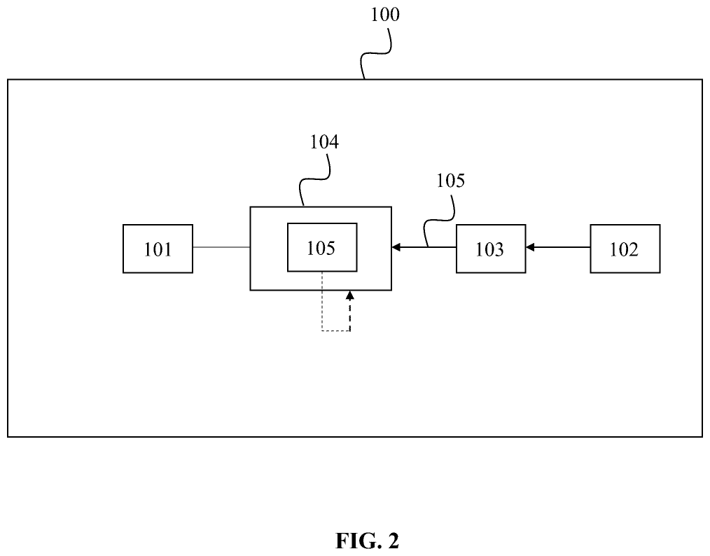

FIG. 2 shows a phased array device 100 according to an embodiment of this disclosure, wherein the reception circuitry 104 is connected or connectable to the antenna array 101, and configured to receive RF signals from the antenna array 101. The transmission circuitry 102 is configured to transmit one or more RF signals 105 to the reception circuitry 104 via the coupling structure 103. The phased array device 100 is configured to calibrate the reception circuitry 104 based on the one or more RF signals 105 from the transmission circuitry 102 received by the reception circuitry 104, which is indicated with a dashed arrow in FIG. 2.

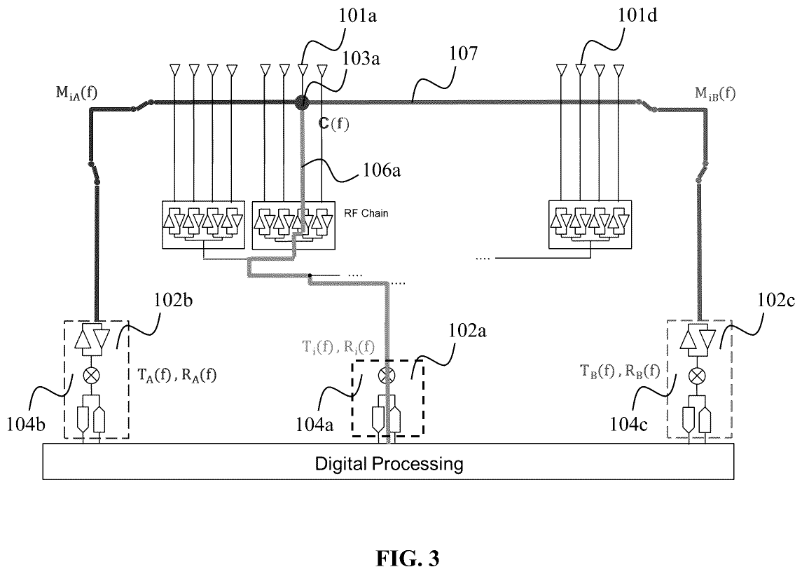

FIG. 3 shows a phased array device according to an embodiment of this disclosure. The phased array device 100 may comprise a first node 102a of the transmission circuitry, a second node 102c of the transmission circuitry, and a third node 102b of the transmission circuitry. The phased array device 100 may comprise a first node 104c of the reception circuitry, a second node 104b of the reception circuitry, and a third node 104a of the reception circuitry.

The phased array device 100 may comprise one or more RF chains. A single calibration line may be used to sense the one or more RF chains through the coupling structure 103, wherein an external probe may not be required. A calibration line may be connected respectively on both terminations to a reference transceiver or ports that are configured to sample/inject signal from/to the active system. By exploiting said two ports phase and amplitude differences among array elements may be determined.

The first node 102a of the transmission circuitry may be an i-th calibration transmitter, for example of an i-th channel. Alternatively, the first node 102a of the transmission circuitry may be calibration transmitter for all channels, for example the calibration transmitter may be shared between all channels. Said single transmitter may generate a single transmit signal, which may then be split into multiple feed signals with individual phase shifts for each antenna of the antenna array 101.

The second node 102c of the transmission circuitry may be a calibration transmitter B.

The third node 102b of the transmission circuitry may be a calibration transmitter A.

The first node 104c of the reception circuitry may be a calibration receiver B.

The second node 104b of the reception circuitry may be a calibration receiver A.

The third node 104a of the reception circuitry may be an i-th calibration receiver, for example of an i-th channel. Alternatively, the first node 104a of the reception circuitry may be calibration receiver for all channels, for example the calibration receiver may be shared between all channels. Said single receiver may receive a single receive signal obtained by adding the individual receive signals from each antenna of the antenna array 101 (with suitable individual phase shifts).

The calibration receiver A and the calibration transmitter A may be comprised in a calibration transceiver A.

The calibration receiver A and/or the calibration transmitter A may be referred to as port A.

The calibration receiver B and the calibration transmitter B may be comprised in a calibration transceiver B.

The calibration receiver B and/or the calibration transmitter B may be referred to as port B.

Each i-th calibration transmitter and each i-th calibration receiver may be comprised in an i-th calibration transceiver, respectively.

The reception circuitry 104 may comprise one or more third nodes 104a of the reception circuitry.

The transmission circuitry 102 may comprise one or more first nodes 102a of the transmission circuitry.

The connection from each first node 102a of the transmission circuitry to the first node 104b of the reception circuitry and the second node 104c of the reception circuitry may form a first set of channels.

The connection from each third node 104a of the reception circuitry to the third node 102b of the transmission circuitry and/or the second node 102c of the transmission circuitry may form a second set of channels.

The first set of channels and the second set of channels may be the same set of channels. For example, each channel of the first set of channels may comprise the same portions of the feed line and/or the signal line as one channel of the second set of channels.

The phased antenna array 100 may comprise a channel for each antenna of the antenna array 101.

Further, the phased array device 100 may comprise a controller for digital processing which may be connected to the reception circuitry 104 and/or the transmission circuitry 102.

To calibrate a phased array system according to this disclosure, the phase imbalance and amplitude losses caused by the coupling structure 103, which may comprise two or more couplers, may be equal or already known. This may not be required for the transmission lines. If the couplers 103a comprised in the coupling structure 103 consist of a same material and are of a same shape, their effects may be substantially equal. In addition, since the calibration procedure according to this disclosure is capable to calibrate up to the position of the coupler 103a in the RF chain, the remaining line from the coupler 103a to the antennas of the antenna array 101 and said antennas may be required to be substantially equal or have predetermined characteristics. If said part of said antennas consists of the same material their effect may be substantially equal. Thus, a dual port single calibration line may be used to calibrate the phased array device 100.

Two assumptions may need to be verified: The first is the equality among couplers and the second is the equality among the radiating elements and their feeding lines. These assumptions may be achieved by the quality of conventional manufacturing processes and may set a performance limit to the calibration accuracy (together with, for example, the couplers accuracy).

An in-factory calibration first and an in-field monitoring to track aging and temperature drift of RF components may be required.

One calibration line may connect all or some of the two or more antennas through non-directive couplers and may terminate on two ports, i.e. both part of the line, where the signals are measured. An external probe may not be required during in factory calibration.

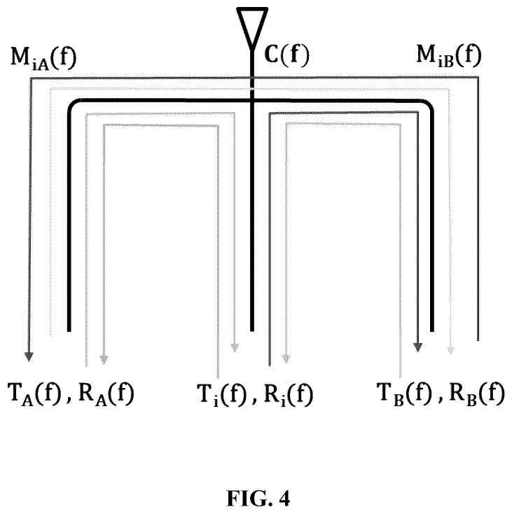

FIG. 4 shows the measurements that can be collected for each channel according to an embodiment of this disclosure.

The phased array device 100 may comprise two or more channels, for example i channels, wherein i may be an integer larger than 1. The phased array device 100 may comprise two channels for each antenna of the antenna array 101, for example, one channel for the calibration receiver A 104b and/or the calibration transmitter A 102b and one channel for the calibration receiver B 104c and/or calibration transmitter B 102c.

The letters shown in FIGS. 3 and 4 represent transfer functions:
TA(f): transfer function of the calibration transmitter A 102b
RA(f): transfer function of the calibration receiver A 104b
TB(f): transfer function of the calibration transmitter B 102c
RB(f): transfer function of the calibration receiver B 104c
Ti(F): transfer function of the calibration transmitter of the i-th channel 102a
Ri(F): transfer function of the calibration receiver of the i-th channel 104a

This calibration concept is valid if analog-to-digital converters (ADCs) and digital-to-analog converters (DACs) are as many as the number of channels (fully digital system) or when they are shared among channels (analog/hybrid systems).

The following measurements may be performed per each channel i (see FIG. 4).

$${m}_{i A} = {T}_{i} ( f ) C ( f ) {M}_{iA} ( f ) {R}_{A} ( f ) \qquad ( 1 )$$

$${m}_{i B} = {T}_{i} ( f ) C ( f ) {M}_{i B} ( f ) {R}_{B} ( f ) \qquad ( 2 )$$

$${m}_{A i} = {T}_{A} ( f ) {M}_{i A} ( f ) C ( f ) {R}_{i} ( f ) \qquad ( 3 )$$

$${m}_{B i} = {T}_{B} ( f ) {M}_{i B} ( f ) C ( f ) {R}_{i} ( f ) \qquad ( 4 )$$

$${m}_{A B} = {T}_{A} ( f ) {M}_{i A} ( f ) {M}_{i B} ( f ) {R}_{B} ( f ) \qquad ( 5 )$$

$${m}_{B A} = {T}_{B} ( f ) {M}_{i B} ( f ) {M}_{i A} ( f ) {R}_{A} ( f ) \qquad ( 6 )$$

It may be assumed that the couplers are substantially equal or identical: Cᵢ(f)=C(f), ∀i.

Since all couplers may be assumed to be identical and the difference between the channels may be equalized, the joint response of i-th channel's transmitter/receiver 102a/104a and coupler 103a may be calculated.

For the following, it is defined that: T_{iC}(f)=Tᵢ(f)C(f) and R_{iC}(f)=Rᵢ(f)C(f).

$${m}_{i A} = {T}_{l C} ( f ) {M}_{iA} ( f ) {R}_{A} ( f ) \qquad ( 7 )$$

$${m}_{i B} = {T}_{i C} ( f ) {M}_{i B} ( f ) {R}_{B} ( f ) \qquad ( 8 )$$

$${m}_{A i} = {T}_{A} ( f ) {M}_{i A} ( f ) {R}_{i C} ( f ) \qquad ( 9 )$$

$${m}_{B i} = {T}_{B} ( f ) {M}_{i B} ( f ) {R}_{i C} ( f ) \qquad ( 10 )$$

$${m}_{A B} = {T}_{A} ( f ) {M}_{i A} ( f ) {M}_{i B} ( f ) {R}_{B} ( f ) \qquad ( 11 )$$

$${m}_{B A} = {T}_{B} ( f ) {M}_{i B} ( f ) {M}_{i A} ( f ) {R}_{A} ( f ) \qquad ( 12 )$$

The calibration of the Transmit Part and the calibration of the Receive Part can be done separately, hence a calibration according to this disclosure may be applied to transmit-only or receive-only arrays. However, the resulting (reduced) equation set cannot be solved using self-calibration. In other words, if transmitter and receiver are calibrated separately, the quantities T_{A}(f), T_{B}(f), R_{A}(f) and R_{B}(f) may be required to be predetermined or known.

The reduced systems of equations are:

For transmit-only (TX ONLY):

$${m}_{i A} = {T}_{i C} ( f ) {M}_{i A} ( f ) {R}_{A} ( f ) \qquad ( 7 )$$

$${m}_{i B} = {T}_{iC} ( f ) {M}_{iB} ( f ) {R}_{B} ( f ) \qquad ( 8 )$$

$${m}_{A B} = {T}_{A} ( f ) {M}_{iA} ( f ) {M}_{iB} ( f ) {R}_{B} ( f ) \qquad ( 11 )$$

$${m}_{B A} = {T}_{B} ( f ) {M}_{i B} ( f ) {M}_{i A} ( f ) {R}_{A} ( f ) \qquad ( 12 )$$

Multiplying the Eq. (7) and Eq. (8) with each other and solving for T_{iC}² leads to:

$${T}_{iC}^{2} = \frac{{m}_{iA} {m}_{iB}}{{M}_{iA} {M}_{iB} {R}_{A} {R}_{B}}$$

T_{iC} may be determined according to a first method based on Eq. (11):

$${M}_{i A} {M}_{i B} {R}_{B} = \frac{{m}_{A B}}{{T}_{A}}$$

$$Hence$$

$${T}_{i C}^{2} = \frac{{m}_{i A} {m}_{i B} {T}_{A}}{{m}_{A B} {R}_{A}}$$

The transfer function T_{iC} can thus be computed (up to a factor of −1, i.e. with a phase ambiguity of 180 degrees) from the three measured transfer functions m_{iA}, m_{iA} m_{AB} and the ratio T_{A}/R_{A}. The ratio T_{A}/R_{A} can be measured at the factory or during maintenance. In addition to the transmitters i=1, . . . , N 102a, the following calibration devices may be used: the calibration receiver A 104b (for measuring m_{iA}), the calibration receiver B 104c (for measuring m_{iA} and m_{AB}), and the calibration transmitter A 102b (for measuring m_{AB}) co-located with the calibration receiver A 104b. The calibration transmitter B 102c and receivers i=1, . . . , N 104a may not be needed in this method.

Alternatively or additionally, T_{iC} may be determined according to a second method based on Eq. (12) instead of Eq. (11):

$${T}_{i C}^{2} = \frac{{m}_{i A} {m}_{i B} {T}_{B}}{{m}_{B A} {R}_{B}}$$

The transfer function T_{iC} can thus be computed (up to a factor of −1, i.e. with a phase ambiguity of 180 degrees) from the three measured transfer functions m_{iA}, m_{iB} m_{BA} and the ratio T_{B}/R_{B}. The ratio T_{B}/R_{B} can be measured at the factory or during maintenance. In addition to the transmitters i=1, . . . , N 102a, the following calibration devices may be needed: the calibration receiver A 104b (for measuring m_{iA} and m_{BA}), the calibration receiver B 104c (for measuring m_{iB}), and the calibration transmitter B 102c (for measuring and m_{BA}) co-located with the calibration receiver B 104c. The calibration transmitter A 102b and receivers i=1, . . . , N 104a may not be needed in this method.

The first and the second TX ONLY method may be combined: T_{iC} is extracted twice, using both the first and the second method, and a final value for T_{iC} may be derived from both, e.g. by taking an average. More accurate and more reliable results can thus be achieved. In this method, calibration receivers A 104b and B 104c and calibration transmitters A 102b and B 102c are used, whereas receivers i=1, . . . , N 104a may not be needed.

For receive-only (RX ONLY):

$${m}_{A i} = {T}_{A} ( f ) {M}_{iA} ( f ) {R}_{iC} ( f ) \qquad ( 9 )$$

$${m}_{B i} = {T}_{B} ( f ) {M}_{iB} ( f ) {R}_{iC} ( f ) \qquad ( 10 )$$

$${m}_{A B} = {T}_{A} ( f ) {M}_{i A} ( f ) {M}_{i B} ( f ) {R}_{B} ( f ) \qquad ( 11 )$$

$${m}_{B A} = {T}_{B} ( f ) {M}_{i B} ( f ) {M}_{i A} ( f ) {R}_{A} ( f ) \qquad ( 12 )$$

Multiplying Eq. (9) and Eq. (10) with each other and solving for R_{iC}² leads to:

$${R}_{i C}^{2} = \frac{{m}_{A i} {m}_{B i}}{{M}_{i A} {M}_{i B} {T}_{A} {T}_{B}}$$

R_{iC} may be determined according to a first method based on Eq. (11):

$${M}_{i A} {M}_{i B} {T}_{A} = \frac{{m}_{A B}}{{R}_{B}}$$

$$Hence$$

$${R}_{i C}^{2} = \frac{{m}_{A i} {m}_{B i} {R}_{B}}{{m}_{A B} {T}_{B}}$$

The transfer function R_{iC} can thus be computed (up to a factor of −1, i.e. with a phase ambiguity of 180 degrees) from the three measured transfer functions m_{Ai}, m_{Bi} m_{AB} and the ratio R_{B}/T_{B}. The ratio R_{B}/T_{B} can be measured at the factory or during maintenance. In addition to the receivers i=1, . . . , N 104a, the following calibration devices may be used: the calibration transmitter A 102b (for measuring m_{Ai} and m_{AB}), the calibration transmitter B 102c (for measuring m_{Bi}), and the calibration receiver B 104c (for measuring m_{AB}). The calibration receiver A 104b and transmitters i=1, . . . , N 102a may not be needed in this method.

Alternatively or additionally, R_{iC} may be determined according to a second method based on Eq. (12) instead of Eq. (11):

$${R}_{i C}^{2} = \frac{{m}_{A i} {m}_{B i} {R}_{A}}{{m}_{B A} {T}_{A}}$$

The transfer function R_{iC} can thus be computed (up to a factor of −1, i.e. with a phase ambiguity of 180 degrees) from the three measured transfer functions m_{iA}, m_{iB} m_{BA} and the ratio T_{A}/R_{A}. The ratio T_{A}/R_{A} can be measured at the factory or during maintenance. In addition to the receivers i=1, . . . , N, the following calibration devices may be needed: the calibration transmitter A 102b (for measuring m_{iA} and m_{BA}), the calibration transmitter B 102c (for measuring m_{iB}), and the calibration receiver A 104b (for measuring and m_{BA}). The calibration receiver B 104c and transmitters i=1, . . . , N 102a may not be needed in this method.

The transceivers A and/or B may be a calibrated transceiver and/or a transceiver with predetermined characteristics or a transceiver of which the T/R ratio is predetermined.

The first and the second RX ONLY method may be combined: R_{iC} is extracted twice, using both the first and the second method, and a final value for R_{iC} may be derived from both, e.g. by taking an average. More accurate and more reliable results can thus be achieved. In this method, calibration receivers A 104b and B 104c and calibration transmitters A 102b and B 102c are used, whereas transmitters i=1, . . . , N 102a may not be needed.

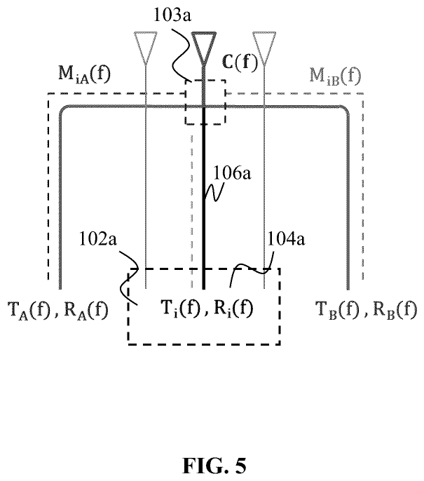

FIG. 5 shows a phased array device 100 comprising a single calibration line according to an embodiment of this disclosure. To calibrate the phased array device 100, the single calibration line may be coupled, for example coupled closely, to all antenna elements across the entire antenna array 101 through the coupling structure 103. The coupling structure 103 may comprise a coupler 103a for coupling the calibration line to the first node 102a of the transmission circuitry and/or the third node 104a of the reception circuitry. The coupling structure 103 may comprise additional couplers for coupling the calibration line to the first node 102a of the transmission circuitry and/or the third node 104a of the reception circuitry or to another first node of the transmission circuitry and/or another third node of the reception circuitry.

The calibration may be determined by measuring the signals at the two edges of said calibration line. No external probe may be required. The manufacturing uncertainties may be reduced by the two common reference channels from the calibration transmitters A 102b and B 102c to the calibration receivers B 104b and A 104c, respectively. The couplers very close or adjacent to the antenna element may be identical or very similar to each other.

The calibration receivers and/or transmitters A 102b, 104b and B 102c, 104c are assumed to be known or characterized in advance (for instance, they may be test equipment or previously measured embedded transceivers).

Calibration may be primarily for equalizing phase/amplitude shifts of antenna elements. However, calibration measurements can also be used for other purposes, e.g. detecting the failure of one channel (from the high attenuation of the corresponding channel relative to other channels).

The relative channel response of each channel can be calculated by solving the Eqs. (1) to (6) as shown above.

The impairments relative to each feed line can be measured twice: one measure of the transmitted signal may be performed on port A 102b and one measure on port B 102c. To remove the uncertainty of the calibration line itself, an additional measure of a signal directly from port A 102b to port B 104c (and/or vice-versa) may be needed. The calibration of the calibration receiver 104a of each i-th channel may be done in a dual way: two measurements of the receiver 104a of each feed line are performed from signals injected into calibration port A 104b and B 104c and measured at the calibration receiver 104a of each i-th channel; an additional measure of a signal directly from port B 102c to port A 104b (and/or vice-versa) may be used to remove the uncertainty of the calibration line itself.

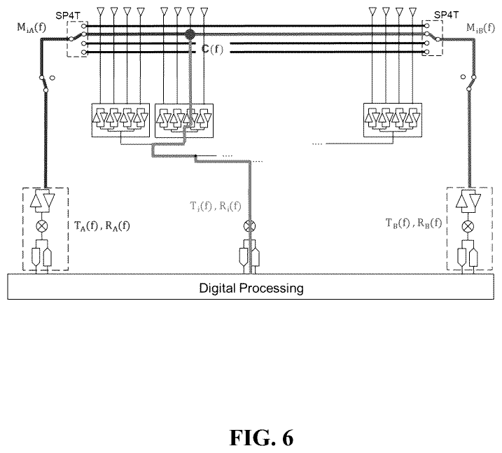

FIG. 6 shows a phased array device 100 according to an embodiment of this disclosure. The calibration line may be divided into a plurality of parallel calibration line core segments, a calibration line start segment and a calibration line end segment as shown in FIG. 6. The calibration line may be divided in accordance to some trade-offs due to simplicity of the implementation, cost, losses of the calibration line. The calibration line start segment may connect the calibration transceiver A 102b and the calibration receiver A 104b to the plurality of calibration line core segments. The calibration line end segment may connect the calibration transceiver B 104b and the calibration receiver B 104b to the plurality of calibration line core segments. Each calibration line core segment of the plurality of calibration line core segments may comprise a coupler 103a, and may be connected or connectable through the coupler 103a to an antenna of the antenna array 101 and the calibration transmitter 102a of a corresponding channel and/or the calibration receiver 104a of the corresponding channel.

The phased array device 100 may comprise two switches (denoted as SP4T in FIG. 6) for connecting respectively the calibration line start segment and the calibration line end segment to one calibration line core segment of the plurality of calibration line core segments. Thus, two channels may be formed for each antenna of the two or more antennas of the antenna array 101.

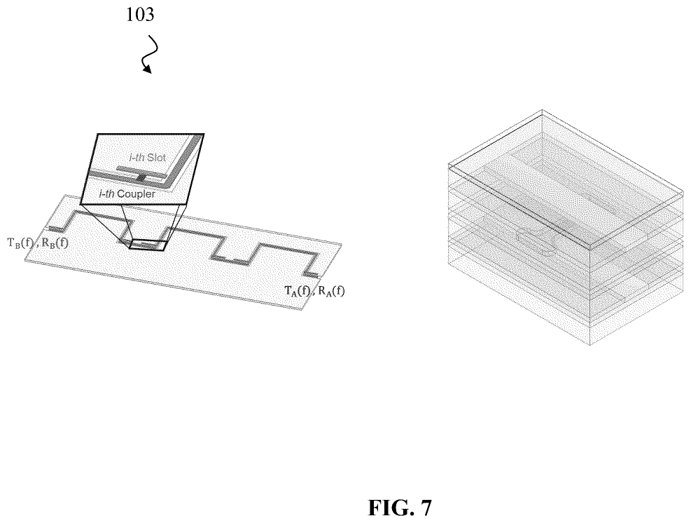

FIG. 7 shows an exemplary coupling structure 103 according to an embodiment of this disclosure. The two or more couplers of the coupling structure 103 may be integrated into a multilayer printed circuit board (PCB).

Another implementation may be based on pure mechanical distribution of the signals (beam forming network).

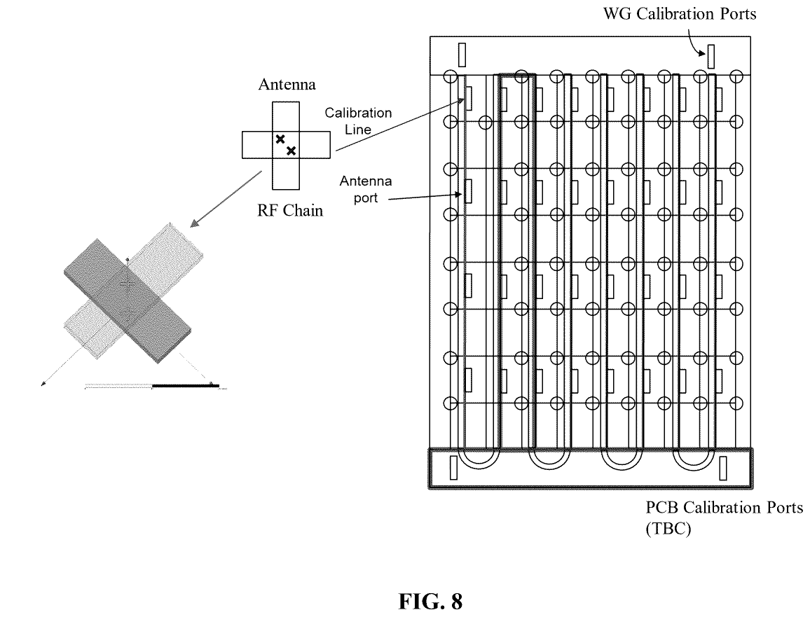

FIG. 8 shows an exemplary implementation of the coupling structure 103 in the mechanic according to an embodiment of this disclosure.

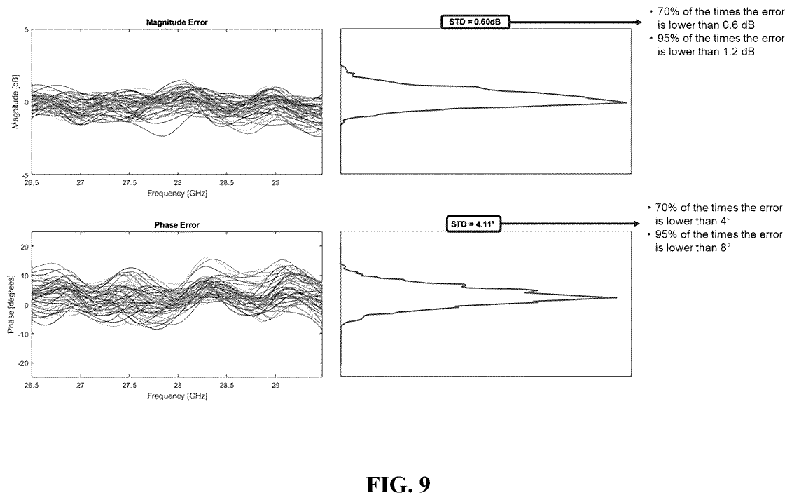

FIGS. 9 to 12 show experimental results obtained by comparing a conventional “near-field scanning probe method” with a “dual port calibration method” according to an embodiment of this disclosure.

FIG. 9 shows a probability density function of the error associated with the calibration of the phased array device 100 according to an embodiment of this disclosure.

A phase imbalance and a amplitude loss caused by each of the two or more couplers may be predetermined and/or substantially equal such that, after the phased array device 100 is calibrated, respective signals associated with the antennas of the antenna array 101 may have compared to each other in a 25 GHz to 30 GHz frequency range amplitude differences with a standard deviation (STD) smaller than 0.6 dB and/or a phase differences with a standard deviation smaller than 4.11°.

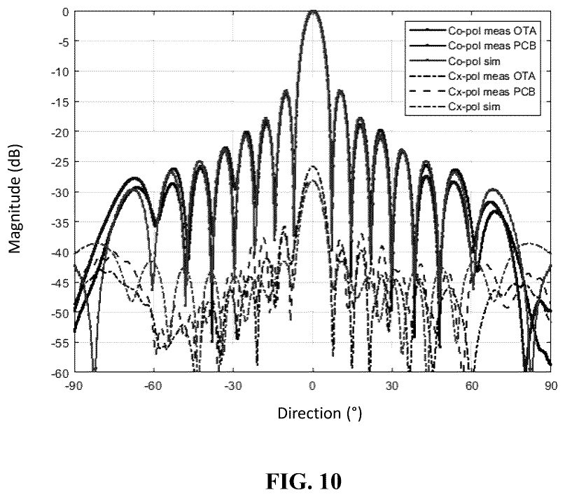

FIG. 10 shows exemplary radiation performances and numerical comparisons of: a phased array device 100 according to an embodiment of this disclosure, a near-field scanning probe, and a high-frequency structure simulator (HFSS) simulation for a boresight radiation pattern.

Thus, a phased array device 100 according to an embodiment of this disclosure may be more efficient.

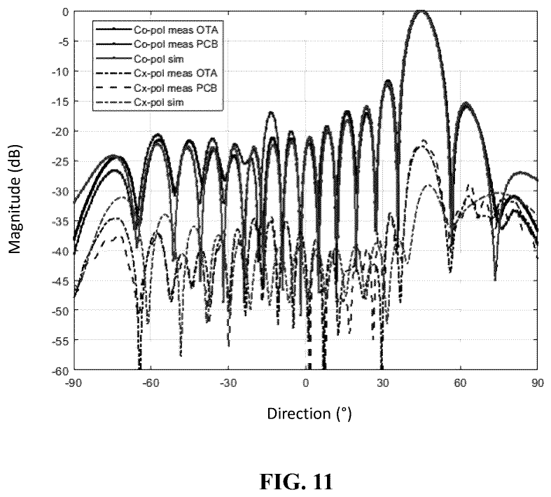

FIG. 11 shows exemplary radiation performances and numerical comparisons of: a phased array device 100 according to an embodiment of this disclosure, a near-field scanning probe, and a HESS simulation for a 45° steered radiation pattern.

Thus, a phased array device 100 according to an embodiment of this disclosure may be more efficient.

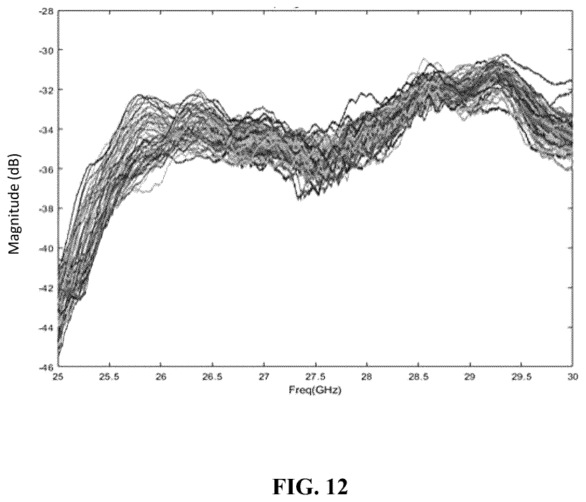

FIG. 12 shows the couplers dispersion of a phased array device 100 according to an example of this disclosure.

The residual error of the calibration of a phased array device 100 according to embodiments of this disclosure may be due to the differences of the two or more couplers arising during manufacturing.

The phased array device 100 may comprise controller. The controller may be a processor.

Generally, the processor may be configured to perform, conduct or initiate the various operations of the phased array device 100 described herein. The processor may comprise hardware and/or may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The phased array device 100 may further comprise memory circuitry, which stores one or more instruction(s) that can be executed by the processor, in particular under control of the software. For instance, the memory circuitry may comprise a non-transitory storage medium storing executable software code which, when executed by the processor, causes the various operations of the phased array device 100 to be performed. In one embodiment, the phased array device 100 may comprises one or more processors and a non-transitory memory connected to the one or more processors. The non-transitory memory may carry executable program code which, when executed by the one or more processors, causes the phased array device 100 to perform, conduct or initiate the operations or methods described herein.

Generally, the phased array device 100 comprises: an antenna array 101 comprising two or more antennas, a reception circuitry 104, a coupling structure 103, and a transmission circuitry 102 connected or connectable to the reception circuitry 104 via the coupling structure 103, wherein the reception circuitry 104 and/or the transmission circuitry 102 are connected or connectable to the antenna array 101.

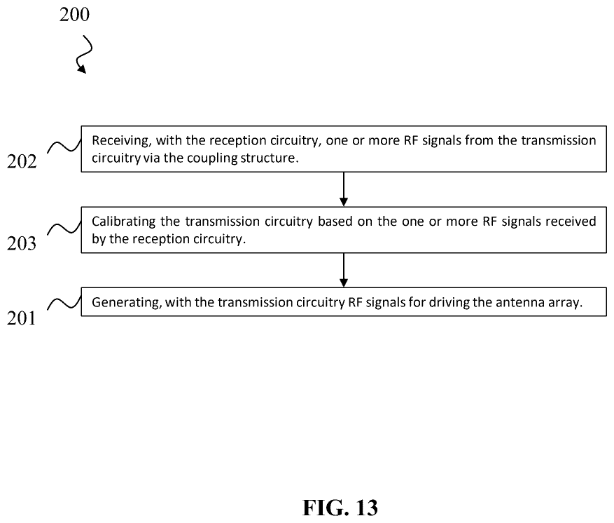

FIG. 13 shows a method 200 according to an embodiment of this disclosure. The method 200 may be performed by the phased array device 100. The method 200 comprises a step 202 of receiving, with the reception circuitry 104, one or more RF signals from the transmission circuitry 102 via the coupling structure 103. Further, the method 200 comprises a step 203 of calibrating the transmission circuitry 102 based on the one or more RF signals 105 received by the reception circuitry 104. Further, the method 200 may comprise a step 201 of generating, with the transmission circuitry 102, RF signals for driving the antenna array 101.

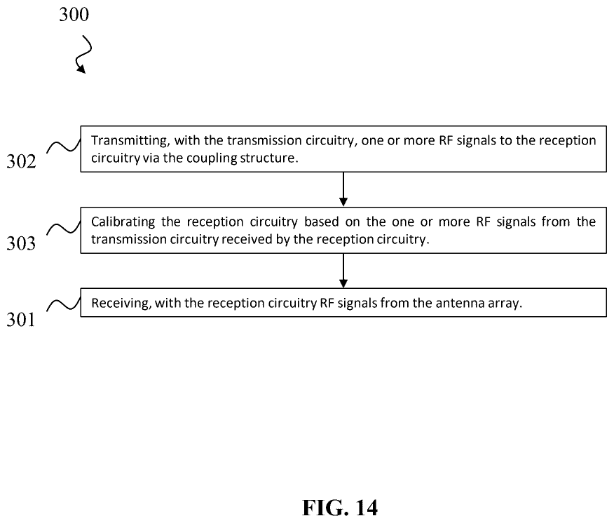

FIG. 14 shows a method 300 according to an embodiment of this disclosure. The method 300 may be performed by the phased array device 100. The method 300 comprises a step 302 of transmitting, with the transmission circuitry 102, one or more RF signals 105 to the reception circuitry 104 via the coupling structure 103. Further, the method 300 comprises a step 303 of calibrating the reception circuitry 104 based on the one or more RF signals 105 from the transmission circuitry 102 received by the reception circuitry 104. Further, the method 300 comprises a step 301 of receiving, with the reception circuitry 104, radio frequency, RF, signals from the antenna array 101.

The disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A phased array device (100) for transmitting a radio frequency, RF, wave, wherein the phased array device (100) comprises:
an antenna array (101) comprising two or more antennas (101a, 101d);
transmission circuitry (102) connected or connectable to the antenna array (101) and configured to generate RF signals for driving the antenna array (101);
a coupling structure (103); and
reception circuitry (104) connected or connectable to the transmission circuitry (102) via the coupling structure (103) and configured to receive one or more RF signals (105) from the transmission circuitry (102) via the coupling structure (103);
wherein the phased array device (100) is configured to calibrate the transmission circuitry (102) based on the one or more RF signals (105) from the transmission circuitry (102) received by the reception circuitry (104).

2. The phased array device (100) of claim 1,
wherein the transmission circuitry (102) comprises a first node (102a) connected or connectable to an antenna (101a) of the antenna array (101) and configured to provide an RF signal for driving the antenna (101a),
wherein the first node (102a) is connected or connectable to the coupling structure (103).

3. The phased array device (100) of claim 2,
comprising a feed line (106a) from the first node (102a) of the transmission circuitry (102) to the antenna (101a),
wherein the coupling structure (103) comprises a coupler (103a) connected to the feed line (106a).

4. The phased array device (100) of claim 2,
wherein the reception circuitry (104) comprises a first node (104b) connected or connectable to the first node (102a) of the transmission circuitry (102) via the coupling structure (103), for receiving a RF signal from the first node (102a) of the transmission circuitry (102) via the coupling structure (103).

5. The phased array device (100) of claim 4, configured to determine a value of a transfer function m_{iA} based on the RF signal from the first node (102a) of the transmission circuitry (102) received at the first node (104b) of the reception circuitry (104), and
calibrate the transmission circuitry (102) based on the value of the transfer function m_{iA}.

6. The phased array device (100) of claim 4,
wherein the reception circuitry (104) comprises a second node (104c) connected or connectable to the first node (102a) of the transmission circuitry (102) via the coupling structure (103), for receiving an RF signal from the first node (102a) of the transmission circuitry (102) via the coupling structure (103).

7. The phased array device (100) of claim 6, configured to
determine a transfer function m_{iA} based on the RF signal from the first node (102a) of the transmission circuitry (102) received at the second node (104c) of the reception circuitry (104); and
calibrate the transmission circuitry (102) based on the value of the transfer function m_{iB}.

8. The phased array device (100) of claim 2,
wherein the transmission circuitry (102) comprises a second node (102c) connected or connectable to the first node (104b) of the reception circuitry (104), for transmitting a RF signal to the first node (104b) of the reception circuitry (104).

9. The phased array device (100) of claim 8,
configured to determine a transfer function m_{BA} based on the RF signal from the second node (102c) of the transmission circuitry (102) received at the first node (104b) of the reception circuitry (104).

10. The phased array device (100) of claim 8, comprising:
a feed line (106a) from the first node (102a) of the transmission circuitry (102) to the antenna (101a), and
a signal line (107) from the second node (102c) of the transmission circuitry (102) to the first node (104b) of the reception circuitry (104),
wherein the coupling structure (103) comprises a coupler (103a) that connects the feed line (106a) to the signal line (107).

11. The phased array device (100) of claim 10,
wherein the second node (104c) of the reception circuitry (104) is connected or connectable to the first node (102a) of the transmission circuitry (102) via the following:
the coupler (103a) and a portion of the signal line that extends from the coupler (103a) toward the second node (102c) of the transmission circuitry (102).

12. The phased array device (100) of claim 10,
wherein the second node (104c) of the reception circuitry (104) is co-located with the second node (102c) of the transmission circuitry (102) in a common location and is connected or connectable to the first node (102a) of the transmission circuitry (102) via the following:
the coupler (103a) and a portion of the signal line that extends from the coupler (103a) to the common location.

13. The phased array device (100) of claim 12,
wherein the signal line (107) comprises a transmission line or a waveguide.

14. The phased array device (100) claim 2,
wherein calibrating the transmission circuitry (102) comprises:
adjusting a phase and/or a gain of the RF signal provided by the first node (102a) of the transmission circuitry to drive the antenna (101a).

15. The phased array device (100) of claim 1,
wherein the coupling structure (103) comprises multiple couplers arranged on the signal line, each coupler connected to a feed line of a respective antenna of the antenna array (101).

16. The phased array device (100) of claim 1,
wherein the reception circuitry (104) is connected or connectable to the antenna array (101) and is configured to receive RF signals from the antenna array (101).

17. A phased array device (100) for receiving a RF wave, wherein the phased array device (100) comprises:
an antenna array (101) comprising two or more antennas (101a, 101d);
reception circuitry (104) connected or connectable to the antenna array (101) and configured to receive RF signals from the antenna array (101);
a coupling structure (103); and
transmission circuitry (102) connected or connectable to the reception circuitry (104) via the coupling structure (103) and configured to transmit one or more RF signals (105) to the reception circuitry (104) via the coupling structure (103);
wherein the phased array device (100) is configured to calibrate the reception circuitry (104) based on the one or more RF signals (105) from the transmission circuitry (102) received by the reception circuitry (104).

18. The phased array device (100) of claim 17,
wherein the reception circuitry (104) comprises a third node (104a) connected or connectable to an antenna (101a) of the antenna array (101) and configured to receive an RF signal from the antenna (101a),
wherein the third node (104a) is connected or connectable to the coupling structure (103).

19. The phased array device (100) of claim 18,
comprising a feed line (106a) from the antenna (101a) to the third node (104a) of the reception circuitry (104),
wherein the coupling structure (103) comprises a coupler (103a) connected to the feed line (106a).

20. A method (200) of operating a phased array device (100) for transmitting a radio frequency, RF, wave, wherein the phased array device (100) comprises:
an antenna array (101) comprising two or more antennas;
transmission circuitry (102) connected or connectable to the antenna array (101);
a coupling structure (103); and
reception circuitry (104) connected or connectable to the transmission circuitry (102) via the coupling structure (103);
wherein the method comprises:
receiving (202), by the reception circuitry (104), one or more RF signals (105) from the transmission circuitry (102) via the coupling structure (103), and
calibrating (203) the transmission circuitry (102) based on the one or more RF signals (105) received by the reception circuitry (104).
